(19) United States
(12) Patent Application Publication
(10) Pub. No.: US 2014/0325376 A1
(43) Pub. Date: Oct. 30, 2014

(54) Interactive Labeling System

(71) Applicant: Mikael Maximilian Hveem, Oslo (NO)

(72) Inventor: Mikael Maximilian Hveem, Oslo (NO)

(73) Assignee: Mikael Maximilian Hveem, Oslo (NO)

(21) Appl. No.: 14/266,822

(22) Filed: Apr. 30, 2014

Related U.S. Application Data
(60) Provisional application No. 61/817,318, filed on Apr. 30, 2013.

(51) Int. Cl. H04L 29/08; G06F 3/0484; G06F 3/0481

(52) U.S. Cl. CPC H04L 67/10; G06F 3/0481; G06F 3/04842
USPC 715/744

(57) ABSTRACT

A method and system for organizing, labeling and displaying activity listings is described. The method and system includes associating each type of activity/event with a shared title—a “label.” The method system may further include linking these labels to an ID, category, tags and frequency of usage. The method and system also includes how to browse and search these labels. Consistent with embodiments of the invention, a user can use textual input, voice activation commands or other forms of input to perform the search and browsing.

### CROSS-REFERENCE TO RELATED APPLICATIONS

This application claims benefit of USPTO Provisional Application No. 61817318, filed 2013 Apr. 30.

### TECHNICAL FIELD

The present disclosure generally relates to data processing techniques. More specifically, the present disclosure relates to methods and systems of organizing, storing and retrieving user-generated event and activity listings by organizing and displaying the content in a system of unique and human- understandable “labels”.

### BACKGROUND

Among online event and activity platforms, there is a general tendency to give similar events different titles in order to distinguish them from one another. (Note: “Events” and “activities” will be used interchangeably in this document.) For example, a 5-on-5 basketball game might be titled “Park Green Basketball Night” or it might be called “5-on-5 Pick-up Game”.Moreover, event titles often do not clearly indicate what the activity “is”, thus leaving it up to the user to spend more time to find the type of activity he/she is looking for. For example, a title such as “The Withering Cold of the North” can just as easily be the title of a talk or a movie, a seminar or a music performance.

For the browsing user on an activity planning/discovery platform, this creates difficulty in getting a quick, orderly and comprehensive overview over the events/activities listings available to her. This difficulty is particularly prevalent when the user is presented with multiple events of different types and categories on the same view. For example, a user only presented with the titles “The Withering Cold of the North”, “Time to have fun!” and “Open Night” might have difficulties in figuring out what each was. Moreover, in addition to making the browsing process more time consuming and difficult, the lack of proper organization also leads to an issue of “duplication”. With the user ignorant of what is already there, there is an increased chance of the user posting a new event that is similar or near identical. This is unfortunate, as in some cases, the users would have been better off joining forces to achieve the common goal.

To address the difficulties related to organizing user-generated event listings, many platforms offer mechanisms that may allow the creator of an event listing to select particular categories for the event they are creating. Subsequently, the browsing user can use these categories to locate the activity. However, such categories are large and disparate, making it difficult for a user looking for a specific type of activity to use them as starting points. For example, a user looking to participate in a basketball game, would not be adequately directed by simply browsing in the “Sports” category.

Another common feature of such a platform to address the problem is to allow the user to search the database of activities based on keywords that relate to any text associated with the existing activities (title, description, location name, tags, etc.). However, a user searching for a specific activity using a keyword (e.g. pick-up basketball) will normally be returned events that may or may not be directly related to the activity the user is seeking. For instance, a user searching for a basketball game to play in might just as likely be returned a sports bar offering “happy hour” as she is to be returned a basketball games that she could join.

Moreover, systems designed to prevent duplication of user generated content, whether by server side content analysis or, on the client side, forcing the user to search first or integrating the post and search, have limited success as these methods still, or a certain degree, depend on the machine or user quickly recognizing the existing events and the fact that events are not necessary duplicates even if they are similar. Organizing the user generated event listings for easy posting and browsing is therefore no easy task.

### SUMMARY OF THE INVENTION

A method and system for organizing and labeling user-generated content, such as event and activity postings, is described. The method includes associating different types of activities/events with different shared titles—“labels.” The method may further include linking these labels to attributes such as ID, category, tags and frequency of usage. A label is a generic, yet customizable, title for an event, which allows grouping of similar events under the same label. A specific event/activity can only have one label, but a label can be associated with more than one event.

The invention also includes a method and system of how the user generated content is browsed, searched and displayed using the label system [FIGS. 4, 5 and 6]. Rather than directly displaying the events, the search and the browse function first retrieves the relevant labels in the database near simultaneously as it retrieves the associated events, thus being able to present the user with a neatly organized overview of labels, as well as the available events associated with them. Consistent with embodiments of the present invention, a user can use textual input, voice activation commands or other forms of input to perform the search and browsing.

### BRIEF DESCRIPTION OF THE DRAWINGS

FIG. 1 is a simple diagram illustration of how some of the main elements in an event-listing platform are related to one another, consistent with some embodiments of the invention.

FIG. 2 is a system level block diagram illustrating some of the system components and functional modules used in implementing an event-listing platform, consistent with some embodiments of the invention.

FIG. 3 is a diagram illustrating a sample selection of events and labels displaying the association between events and labels.

FIG. 4. shows an example of a user interface consisting of multiple user-generated event/activity listings 02, each organized under their own label 01, consistent with some embodiments of the invention.

FIG. 5. illustrates an example of an user interface consisting of multiple user-generated event/activity posts 02, all belonging to the same label 01, consistent with some embodiments of the invention.

FIG. 6. presents an example of an user interface for a simultaneous label and activity/event search, consistent with some embodiments of the invention.

FIG. 7. is a flow diagram illustrating an example of a method of processing a user's request and presenting her with matching labels and events, consistent with some embodiments of the invention.

### DETAILED DESCRIPTION OF THE INVENTION

Methods and systems for making it easier and less time consuming to find and browse user generated event listings by organizing them into specific, recognizable and descriptive labels.

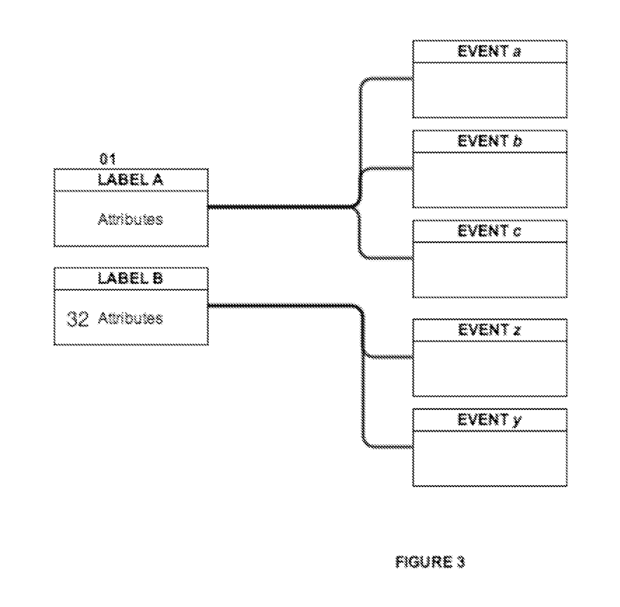

FIG. 3 shows how some of the main elements in an event-listing platform are related to one another, consistent with some embodiments of the invention. The Interactive Label System gives each individual of event listing 02 a unique label 01 to which attributes 32 such as ID, category, tags and frequency of usage may be linked. Labels 01 are independently created by users and stored as a separate object to which event listings 02 may be linked. Each individual event listing 02 may be assigned to a label 01 manually by a human or by a machine driven classification system.

A label 01 is a generic title for an event/activity listing 02, which allows grouping of similar events under the same label 01. One event/activity post 02 can only have one label 01, but one label 01 can be associated with multiple event/activity posts 02. As part of the attributes 32, the system may use aggregated and anonymous data on the frequency/count of usage of each label 01 to provide a hierarchy of the most commonly used labels 01. This is then used to rank the labels, ordered from high count to low count, when multiple labels match the user input in a search.

Moreover, labels 01 may be connected to localities (e.g. cities, countries, regions) to promote local names for different activities. Their unique IDs allows translation of the same type of event created elsewhere.

By type of activity, we mean a group of activity having one or more characteristics that may be used to recognize them as similar in respect to “what type” (e.g. a talk, TED talk, basketball game, University Lecture), but not necessarily in regards to what content (e.g. a talk on “Paradigm Shifts in Biotechnology”). A label 01 is thus specific enough to describe an event (e.g. Basketball Game, Wine Tasting, Happy Hour, Talk), but broad enough to be used again to describe a similar event. Examples of labels 01 includes but are not limited to; Basketball Pickup, University Lecture, Wine Tasting, Brunch, Community Dinner, etc.

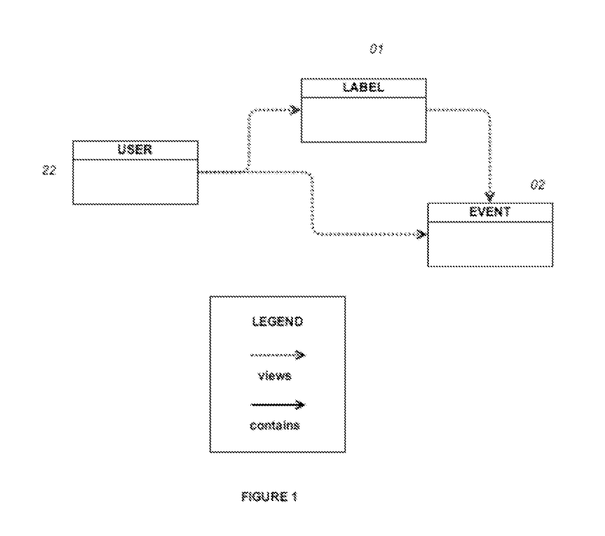

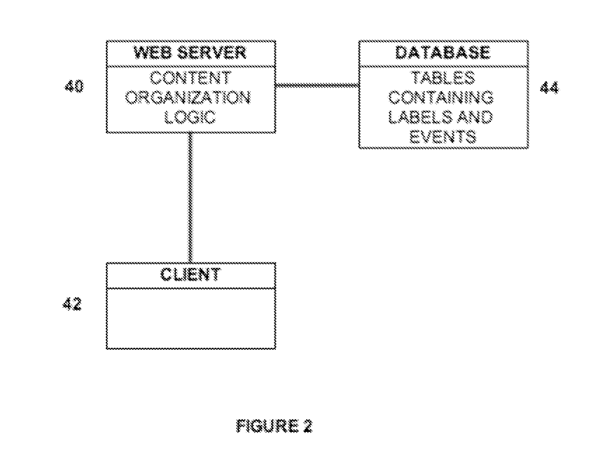

FIG. 1 Shows a general picture of how users 22 interact with labels 01 and event listings 02. As illustrated, interaction with the event listing 02 goes directly or indirectly through a label 01. FIG. 2 shows a general view of a computer system on which an event-listing platform could be built, consistent with some embodiments of the invention.

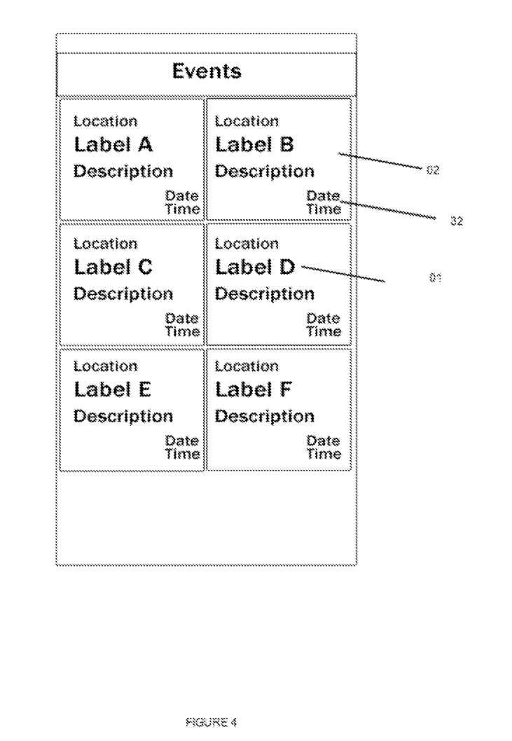

In FIG. 4 there is an example of a client user interface for a system and method for organizing and displaying user-generated event listings 02, in a social network environment administered by a social network server. Consistent with some embodiments of the invention, each event listing 02 displays a label 01 and some associated information 32. By displaying the labels 01 as the prominent element, the user get's a better overview of the different event listings 02 available. Moreover, each label displayed may contain more than one event listing when selected. Having event listings 02 belonging to different categories on the same page is now less confusing as the labels 01 gives the user a “hook” to better understand the subject. For example, a view consisting of “Basketball Game”, “Policy Talk”, “Composting Workshop”, etc. give the user a good overview of the available events.

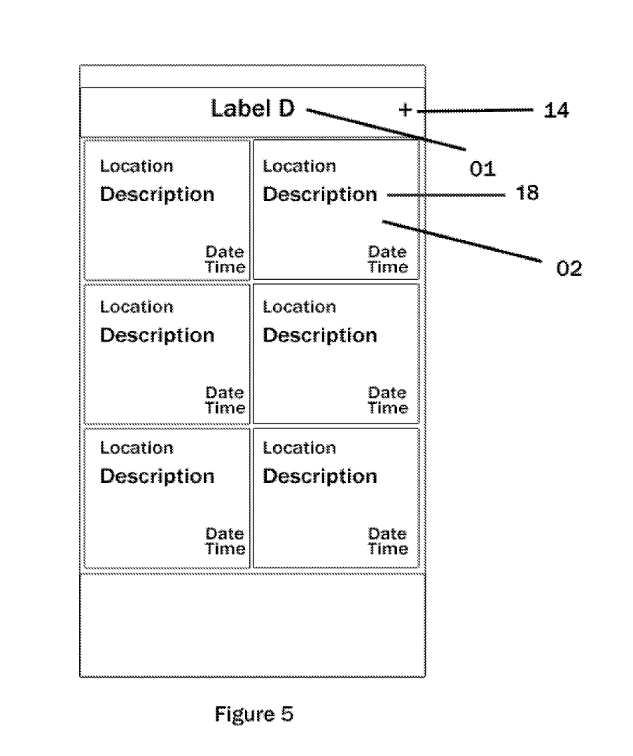

FIG. 5 displays an example of a client user interface that is displayed when a user requests to see the event listings 02 associated with a specific label 01. The user is then displayed the main label clearly indicated in the view, and secondary-information 18 such as descriptions that help distinguish the similar events. For instance, the user might want to see all the “Basketball Games” that are available, and by selecting that label she will be presented with the various basketball game event listings available.

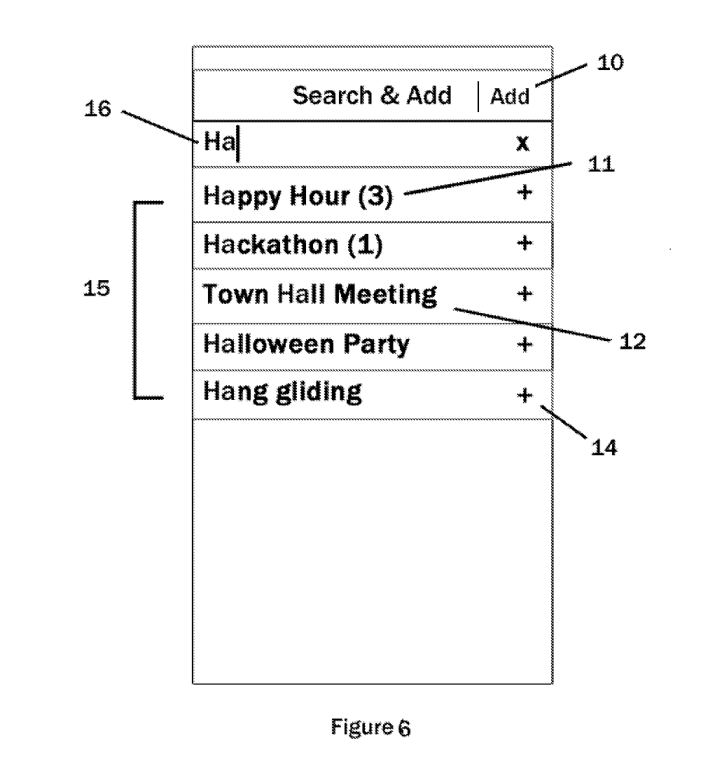

When searching, FIG. 6 illustrates an example of how the user is presented with a view of matching labels 15 at (almost) the same time as the user inputs the search text 16, consistent with some embodiments of the invention. The example shows labels both with associated events (illustrated by a number) 11 and labels without associated events 12. The user may tap the “+” 14 icon to directly add a new event under the associated label. The user may tap one of the labels with associated events 11 to view the list of the associated events (See FIG. 5 for an illustration of this). The user can also tap the “Add” 10 to add the entered label, at which point she may be required to select an associated attribute, such as category, for the new label. Consistent with embodiments of the invention, a user is not limited to using textual input—voice activation commands or other forms of input to perform the search are possible. Moreover, the retrieved information can be communicated using other mediums than text, such as voice, vibrations and other signals.

This system—where the user is presented a view of event labels first, and then secondarily of the associated events [FIG. 6]—presents the user with a neatly organized overview of labels, and the available events associated with them. Furthermore, for the creating user, by instantaneously showing him/her the related labels to his text input, the user is incentivized to use one of the already existing labels 15, knowing that these will allow the event to better reach the right audience.

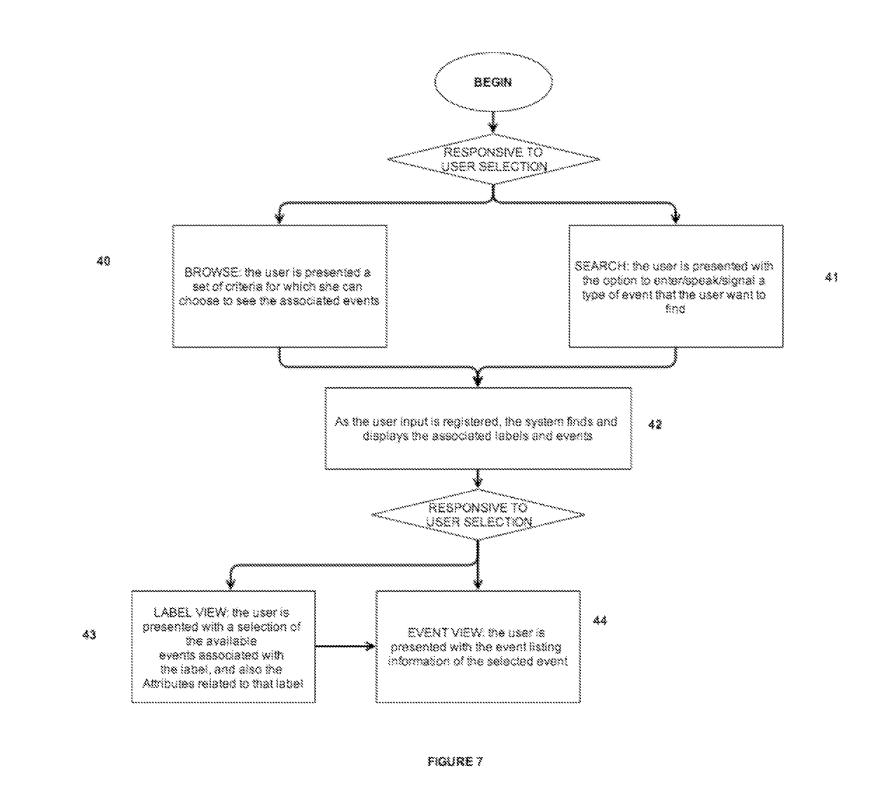

FIG. 7 is a flow diagram illustrating an example of a method of processing a user's request and presenting her with matching labels and events, consistent with some embodiments of the invention. As illustrated in FIG. 7, the method begins at method operation 40 and 41.

At method operation 40, as a result of the user selecting the BROWSE user interface element, the user is presented with a set of criteria for which she wants to see associated events. For instance, this can be limiting the events to the ones available in a specific neighborhood.

At method operation 41, as a result of the user selecting the SEARCH user interface element, the user is presented with the option to enter/speak/signal a type of event that the user want to find. The method and system queries the database of previously created labels while near simultaneously searching the number of interactions that are connected to those labels. The result displays the labels matching the search as well as number of upcoming activities that are associated with the label in the relevant locality that is pre-specified for the search. For example, the user might want to find a basketball game and could enter “basketball game”. In some embodiments, the search uses the frequency of past and current usage for each label to rank the most popular matching labels in the search results (the more popular ones being ranked higher.) Users are thus displayed the most used labels for the activities/criteria that he/she is.

Next, at method operation 42, as the user input is registered, the system finds and displays the associated labels and events. Symbols, text, voices, sounds and/or numbers may indicate labels with associated upcoming activities. Labels without upcoming associated events are also displayed, making the presentation not only of existing activities but also of other suggestions of possible activities. For example, this might be a selection of basketball games that are organized by a label.

Next, at method operation 43, as a result of the user selecting the LABEL VIEW, the user is presented with a selection of the available events associated with the chosen label as well as the attributes related to that label. Following the example above, the user may see the past frequency/count of basketball games by looking at the label attributes, as well as find a list of current basketball games.

Next, at method operation 44, as a result of the user selecting an individual event either directly from method operation 42 or indirectly through 43, the user is presented with the event listing information of the selected even. Continuing with the example above, the user may see the details of a specific basketball game.

By giving each type of event/activity listing 02 a unique label 01, several benefits are achieved:
a) similar activity/event listings 02 carry the same label and are easily browsable
b) duplicates are reduced as event/activity listings 02 are more easily recognizable
c) activity/event listings 02 are less likely to be misidentified, allowing for better overview and instant recognition
d) ability to better assure that related activity/event listings 02 are presented to the user when these are requested [see FIG. 5, moreover the user may tap the “+” 14 icon to add a new event/activity under the relevant label 01]
e) more information can be collected for each type of activity/event posts 02—data which can be used to provide a greater customized user experience.

These strengths address many of the issues described above (chaotic and time consuming overview) that are normally associated with event listing platforms

To highlight the features of the invention, not all aspects and details of the user interface elements are highlighted, but rather those elements specifically necessary to accentuate the invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. An interactive label system for organizing user generated event listings compromising;
a server system that links human recognizable shared titles (labels) to multiple event listings, and
a client user interface grouping and displaying event listings by their associated labels,
wherein the server system structures and powers the client user interface.

2. The invention of claim 1, wherein each individual event listing may be assigned to a label manually by a human or by a machine driven classification system.

3. The invention of claim 1, wherein a label is a generic title for an event/activity listing which allows grouping of similar events under the same label.

4. The invention of claim 1, wherein one event listing can only have one label, but one label can be associated with multiple event/activity posts.

5. The invention of claim 1, wherein labels are independently created by users and stored as a separate object to which event listings may be linked

6. The invention of claim 1, wherein a label is specific enough to describe an event (e.g. Basketball Pickup, University Lecture, Composting Workshop), but broad enough to be used again to describe a similar event.

7. The invention of claim 1, further comprising a set of attributes associated with each label.

8. The invention of claim 7, wherein one attribute is a count of the number of times the label has been assigned to an event within the specific area that can be used to rank labels higher when allowing users to search for labels

9. The invention of claim 7, wherein another attribute is an unique ID that allows the label to be recognized over multiple languages.

10. The invention of claim 7, wherein another attribute is a category that facilitates the grouping of similar labels.

11. An event listing platform hosted on one or more servers, at least one of the servers having a processor and memory storing instructions, which, when executed by the processor, cause the server to perform a method comprising:
presenting as part of a user interface of the event listing platform a user browseable and selectable overview of event listings organized by their associated labels, and an input option that can receive the user's requests for what labels and event listings she is looking for; and
as the user input from the client is received, processing the received request to simultaneously identify existing labels and event listings that have information satisfying a query based on the received input, and to communicate the information of the identified labels and associated event to the client device for a presentation that is one in which event listings are grouped and presented as a subset of their common labels; and
as the user selection of which individual label or event listing to be viewed is received, processing the received request to communicate on the client a set of available event listings under the selected labels, and, when selected, the specific details of a single event listing.

12. The platform of claim 11, wherein the presented event listings are organized by being grouped under associated labels.

13. The platform of claim 11, wherein the input options enables various forms for inputs such as voice commands, text input, signaling, and other forms of communication can be used to perform the search and browsing of event listings and labels.

14. The platform of claim 11, wherein query results may be presented to the user as voice signals, text, or other forms for communication.

15. The platform of claim 11, wherein the user is presented a view of event labels first, and then secondarily of the associated events grouped by labels, creates a neatly organized overview of labels, and the available events associated with them.
